(19) United States
(12) Patent Application Publication
(10) Pub. No.: US 2010/0296199 A1
(43) Pub. Date: Nov. 25, 2010

(54) LOW HYSTERESIS BEARING

(76) Inventor: Zine-Eddine Boutaghou, North Oaks, MN (US)

Correspondence Address: Clise, Billion & Cyr, P.A., 605 U.S. Highway 169, Suite 300, Plymouth, MN, 55441, US

(21) Appl. No.: 12/784,798

(22) Filed: May 21, 2010

Related U.S. Application Data
(60) Provisional application No. 61/180,854, filed on May 23, 2009.

(51) Int. Cl. G11B 5/55; F16C 33/58

(52) U.S. Cl. 360/264; 384/569; G9B/5.182

(57) ABSTRACT

A low hysteresis pivot bearing suitable for a variety of applications. The relationship between torque and angular displacement is substantially linear, with negligible residual hysteresis. The pivot bearing includes a pivot shaft and an inner sleeve pivotally attached to the pivot shaft by an inner bearing. An outer sleeve is pivotally attached to the inner sleeve by an outer bearing. An inner sleeve actuator continuously rotates the inner sleeve relative to the stationary shaft.

### CROSS-REFERENCE TO RELATED APPLICATIONS

This application claims the benefit of the filing date of U.S. Provisional Patent Application Ser. No. 61/180,854 filed May 23, 2009, which is entitled “Low Hysteresis Bearing” which is hereby incorporated herein in its entirety by reference.

### FIELD OF THE INVENTION

The present invention relates to a low hysteresis bearing suitable for a variety of applications, including as a pivot bearing for a rotary actuator within disk drives.

### BACKGROUND OF THE INVENTION

Hard disk drives 30, such as illustrated in FIG. 1, employ rotary actuators 32 that position magnetic transducers 34 over selected information tracks on rotating magnetic disks 36. An example of a pivot bearing is disclosed in U.S. Pat. No. 6,631,053 (Chew). The transducers 34 are positioned with great accuracy by a closed-loop, servo system driven by voice coil motor (VCM) 38. The feedback in the control loop is provided by transducer 34 reading servo information pre-written on the magnetic disk 36.

Rotatable housing 58 on pivot bearing 40 supports rotation of suspension arms 42 through arc 44. In most hard disk drives, the suspension arm 42 is actually a plurality of suspension arms supported by an E-block. (See for example FIG. 3 of U.S. Pat. No. 6,411,471). During track following or track-to-track seek operations, the rotation can be less than one about minute. During seek operations the rotation can be as much as about 20 degrees.

The rotating magnetic disks 36 are subject to spindle run-out 36A. The pivot bearing 40 is subject to frictional resistance and run-out. In order to minimize tracking error, the pivot bearing 40 preferably has low frictional resistance to rotation, minimal run-out, and an evenly distributed pre-load on the bearing assembly.

FIG. 2 illustrates the pivot bearings 40 in greater detail. The pivot bearing 40 employs two spaced sets of ball bearings 50A, 50B (collectively “50”) housed in annular races 52A, 52B (collectively “52”) that are mounted between a shaft 56, and a rotatable housing 58. The shaft 56 is mounted on a base of the disk drive 30 and the rotary actuator 32 is mounted on the rotatable housing 58.

The ball bearings 50A, 50B are pre-loaded so that each exerts a small axial force P on the other to eliminate the internal clearances of the ball bearings 50A, 50B. The pre-load force P has to be adjusted carefully to provide adequate dynamic properties, without increasing the frictional resistance to rotation (torque) of the pivot bearing 40 to an unacceptable extent. If the pre-load P is too high, bearing life will be short, raceway noise will increase, and bearing starting and running torque will increase. If the applied pre-load P is insufficient, corrosion can occur due to vibration causing the balls to resonate and abrade on the raceways. Therefore, obtaining the correct pre-load P is very important.

Both starting torque and running torque are significant to operation of the disk drive 30 and lowering both as much as possible is highly desirable, particularly for high track density applications. Starting torque includes metal-to-metal contact between the ball bearings 50 and the annular races 52, and lubricant shearing. Running torque includes retainer drag (on both ball bearings 50 and the annular races 52) and lubricant churning caused by couplings between balls and retainer, and retainer and raceways. Torque also has a direct effect upon temperature generation, speed variation, power consumption (at start-up and during running), and power consumption variations caused by unstable rotation.

Starting torque is observed in conventional pivot bearings when moving from rest to a steady through a small but finite angle of rotation. A similar transient torque is observed when the direction of rotation is reversed so that, in a pivot bearing undergoing oscillating rotations of small amplitude, the resistance torque traces out a hysterisis loop as a function of angle of rotation. Unfortunately, by the time the pivot bearing is driven out of its stick/slip starting torque state and into rotary movement, excessive driving current may have been applied to the voice coil motor, and the transducer head can be mis-positioned with respect to the desired track position. A system with hysteresis can be summarized as a system that may be in any number of states, independent of the inputs to the system. In the case of a disk drive, torque applied to the pivot bearing does not necessarily correlate to the position of the transducers.

The torque required to rotate a pivot bearing depends on a number of variables, including the elasticity of the ball bearing material, the geometry of the ball bearings, and the nature of the lubricant. During small motions the ball bearings respond to an applied force by deforming elastically. In response to small oscillating rotations of a conventional pivot bearing, the resistance torque traces out a hysteresis loops, such as for example the hysteresis loop as shown in FIG. 3. (Todd et al., A Model for Coulomb Torque Hysteresis in Ball Bearings, Vol. 29, No. 5 International Journal of Mechanical Sciences, pp. 339-354, (1987)). As is illustrated in FIG. 3 the pivot bearing's responses is non-linear. The impact of this dynamic behavior is becoming increasingly important as the data density in disk drives increases.

The current practice in disk drives is to reduce the pre-load on the ball bearing (i.e., the stiffness of the pivot bearing) in order to reduce the elastic deformation of the ball bearings at the races. This reduction in stiffness leads to increased run-out, particularly when the actuator assembly is exposed to vibrations emanating from short and long seeks and external vibrations. The practice of reducing the pivot bearing stiffness in order to improve the track to track seeking of the actuator assembly is leading the industry to migrate to suspension-based micro-actuator to counteract the resulting run-out.

As areal density on a disk drive approaches 1 Terabyte/inch² (1 Tbit/in²) it is expected to increase tracks per inch to about 600,000-800,000 with a spacing between tracks of about 25 nanometers. The hysteresis torque generated in the pivot bearing is becoming increasingly important in high density track recording applications. It is highly desirable to achieve a linear relationship between the required torque and the angular rotation of the suspension arm with negligible residual hysteresis and maximum stiffness of the pivot bearing to meet the high bandwidth requirements.

U.S. Pat. No. 5,755,518 (Boutaghou) discloses a bearing design for a rotatable assembly includes two freely rotating balls mounted on the axis of rotation of the assembly and axially separated, one near each axial end of the assembly. Each ball is confined by a moving concave (preferably conical or frustro-conical) bearing surface of the rotatable assembly and a corresponding fixed concave bearing surface of a mounting attached to a frame, housing, or similar non-rotating structure. One of the fixed mountings is preferably attached to a compressible spring to provide a controlled axial pre-load to the assembly. The balls are substantially enclosed and lubricant provided in the enclosed cavity.

U.S. Pat. No. 5,835,309 (Boutaghou) discloses an arrangement in which two freely rotating balls are mounted on the axis of rotation of an actuator and are axially separated, one at each axial end of the assembly. Each ball in this arrangement is confined by a moving concave bearing surface of the rotatable actuator and a corresponding fixed concave bearing surface of a fixed component. This structure, however, principally improves shock resistance at the expense of increased friction because the area of contact between the balls and the concave bearing surfaces is increased compared with a conventional design using multiple balls in an annular race.

U.S. Pat. No. 6,636,386 (Boutaghou) discloses a disc drive with a base including an axle shaft, a disc stack rotationally mounted to the base, a head assembly coupled to the disc stack, a voice coil and a bearing. The bearing has an inner hub rotationally mounted on the axle shaft, and an outer hub that mounts the voice coil and the head assembly. The outer hub is rotationally mounted to the inner hub through a plurality of flexible spokes that are integrally formed with the inner and outer hubs. The flexible spokes allow the outer hub to rotate when the inner hub is stopped by stiction, also referred to as starting torque. Integral forming provides a predictable response desired for a disc drive.

Various alternatives such as knife edge type pivot bearings are disclosed in Lawsen (U.S. Pat. No. 6,078,475); Liu et al. (U.S. Pat. No. 6,411,471); Oveyssi (U.S. Pat. No. 6,856,492); Boutaghou (U.S. Pat. No. 5,755,518); and Schulze (U.S. Pat. No. 5,355,268). Pivot bearings have met with major cost, reliability and manufacturing drawbacks Knife edge designs do not resolve the intrinsic problem of elastic deformation between the knife edge and the supporting structure during micro-actuation. The knife edge pivots also have very low stiffness leading to impractical translation modes of the suspension arm.

### BRIEF SUMMARY OF THE INVENTION

The present invention is directed to a low hysteresis pivot bearing suitable for a variety of applications. The relationship between torque and angular displacement is substantially linear, with negligible residual hysteresis. The present pivot bearing decouples stiffness from hysteresis, without increasing translation error. When used as a pivot bearing for a rotary actuator within disk drives, expensive micro-actuators on the head gimbal assembly are unnecessary.

One embodiment is directed to a pivot bearing for use in a rotary actuator of a hard disk drive. The pivot bearing includes a pivot shaft and at least one inner sleeve pivotally attached to the pivot shaft by an inner bearing. An outer sleeve is pivotally attached to the inner sleeve by an outer bearing. An inner sleeve actuator continuously rotates the inner sleeve relative to the stationary shaft.

The inner sleeve actuator can be coupled to the pivot shaft and an inner surface of the inner sleeve. In another embodiment, the inner sleeve is coupled to a distal end of the inner sleeve. In one embodiment, the inner sleeve is a DC motor with a magnet mounted to one of the inner sleeve or the stationary shaft and a stator mounted to the other of the inner sleeve or the stationary shaft.

In one embodiment, the inner sleeve rotates between about 1 revolution per minute to about 10 revolutions per minute. In another embodiment, hydrodynamic features are provided at one or more interfaces between the pivot shaft, the inner sleeve, and the outer sleeve. The inner sleeve is then rotated at a sufficient rate to generate an air bearing at the interfaces.

In one embodiment, the inner sleeve is not powered by a motor. Rather, the inner sleeve is free to spin due to the rotation of the inner and outer ball bearings due to torque applied by the voice coil actuation. The constraints on the ball bearings are reduced, thus substantially reducing the hysteresis effects.

The relationship of torque applied to the pivot bearing to angular displacement of the pivot bearing is preferably substantially linear. A controller can be programmed to actuate the inner sleeve actuator only during position critical rotation. The rotation of the inner sleeve displaces the bearing to minimize formation of meniscus films of lubricant on the inner and outer bearings.

The present invention is also directed to a hard disk drive including a suspension arm that position magnetic transducers over selected information tracks on rotating magnetic disks. The pivot bearing rotatably supports at least one suspension arm relative to the rotating magnetic disks. The pivot bearing includes at least one inner sleeve pivotally attached to the pivot shaft by an inner bearing, at least one outer sleeve pivotally attached to the inner sleeve by an outer bearing, and at least one inner sleeve actuator adapted to continuously rotate the inner sleeve relative to the stationary shaft.

A controller is programmed to actuate the inner sleeve actuator only during position critical rotation. The controller can be a servo controller for a hard disk drive. The controller can be programmed to rotate the inner sleeve continuously or intermittently. The controller can also be programmed to rotate the inner sleeve in a same direction or opposite direction of rotation of the outer sleeve. In one embodiment, the controller is programmed to apply one of a current or voltage to a voice coil motor attached to the suspension arm that is proportional to a current or voltage applied to the inner sleeve actuator.

The present invention is also directed to a method of operating a hard disk drive. At least one suspension arm is supported by an outer sleeve of a pivot bearing. An inner sleeve of the pivot bearing arranged concentric with the outer sleeve is rotated relative to a pivot shaft. The suspension arms and the outer sleeve are rotated independently from the rotation of the inner sleeve to position magnetic transducers attached to the suspension arms over selected information tracks on rotating magnetic disks.

### BRIEF DESCRIPTION OF THE SEVERAL VIEWS OF THE DRAWING

FIG. 1 is a schematic illustration of a hard disk drive.

FIG. 2 is a schematic illustration of a pivot bearing for the hard disk drive of FIG. 1.

FIG. 3 is an exemplary hysteresis curve for a prior art pivot bearing.

FIG. 4 is a side sectional view of a pivot bearing in accordance with an embodiment of the present invention.

FIG. 5 is a perspective view of the pivot bearing of FIG. 4.

FIG. 6 is an exploded view of the pivot bearing of FIG. 4.

FIG. 7 is a graph of a torque displacement curve for a pivot bearing in accordance with an embodiment of the present invention.

FIG. 8 is a schematic illustration of a pivot bearing with upper and lower inner sleeves in accordance with an embodiment of the present invention.

FIG. 9 is a schematic illustration of a pivot bearing with an external motor driving the inner sleeve in accordance with an embodiment of the present invention.

FIG. 10 is an exploded view of a pivot bearing with air bearing surfaces in accordance with an embodiment of the present invention.

FIG. 11 is a side sectional view of the pivot bearing of FIG. 10.

FIG. 12 is a perspective view of a stationary bearing shaft of the pivot bearing of FIG. 10.

FIG. 13 is a perspective view of an inner sleeve of the pivot bearing of FIG. 10.

FIG. 14 is a perspective view of an outer bearing shell of the pivot bearing of FIG. 10.

FIG. 15 is a schematic illustration of a disk drive with a pivot bearing in accordance with an embodiment of the present invention.

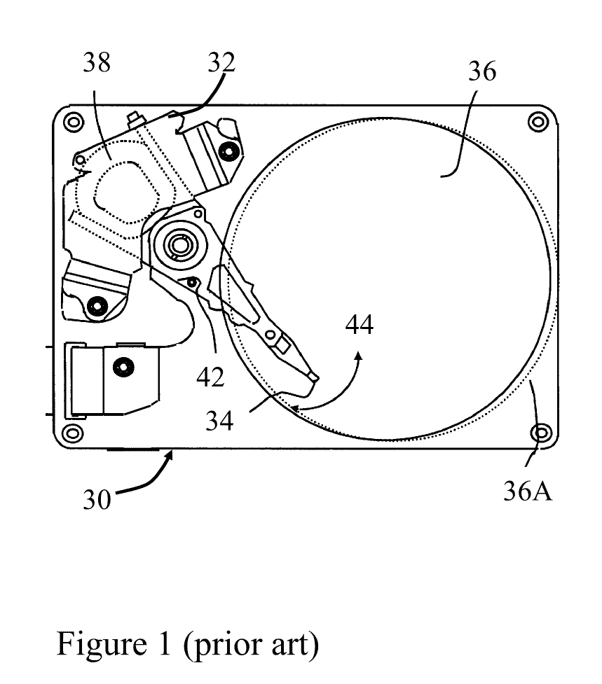

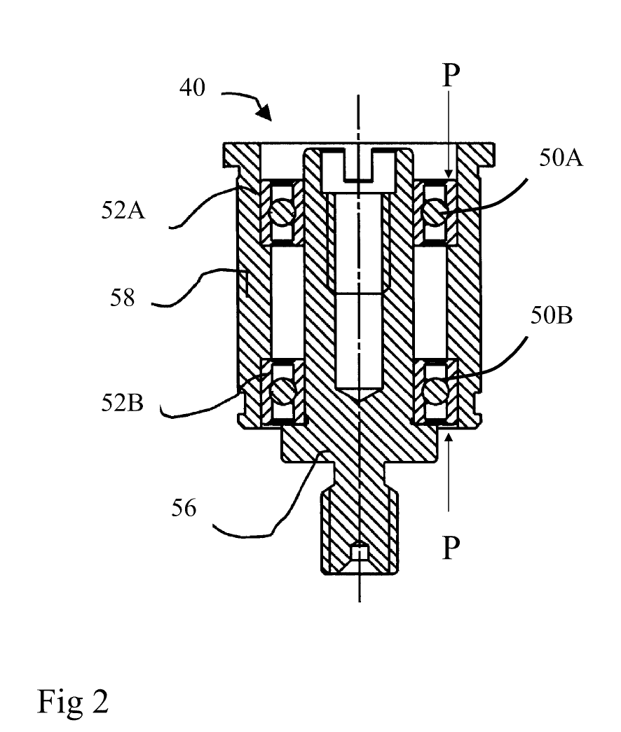

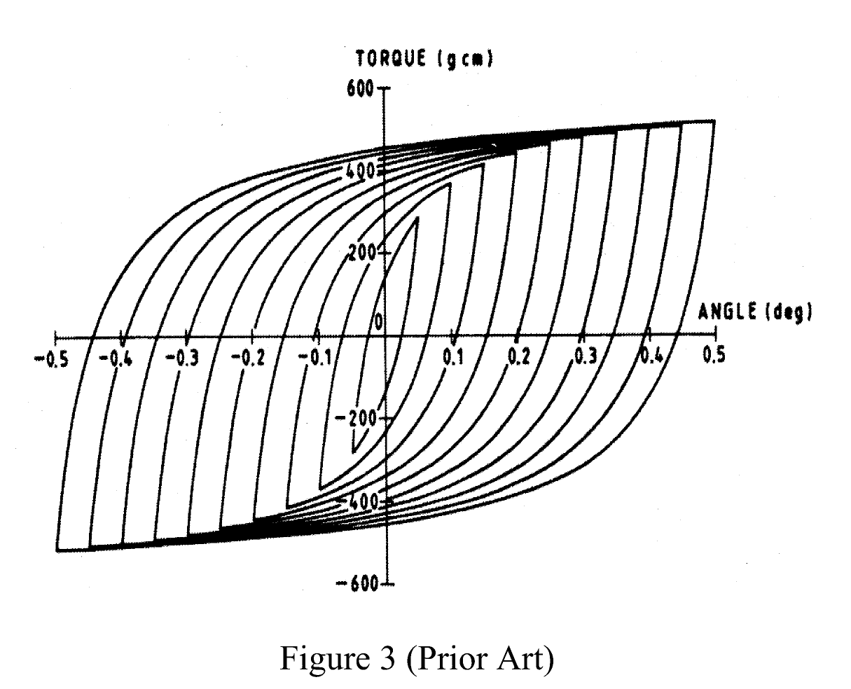

### DETAILED DESCRIPTION OF THE INVENTION

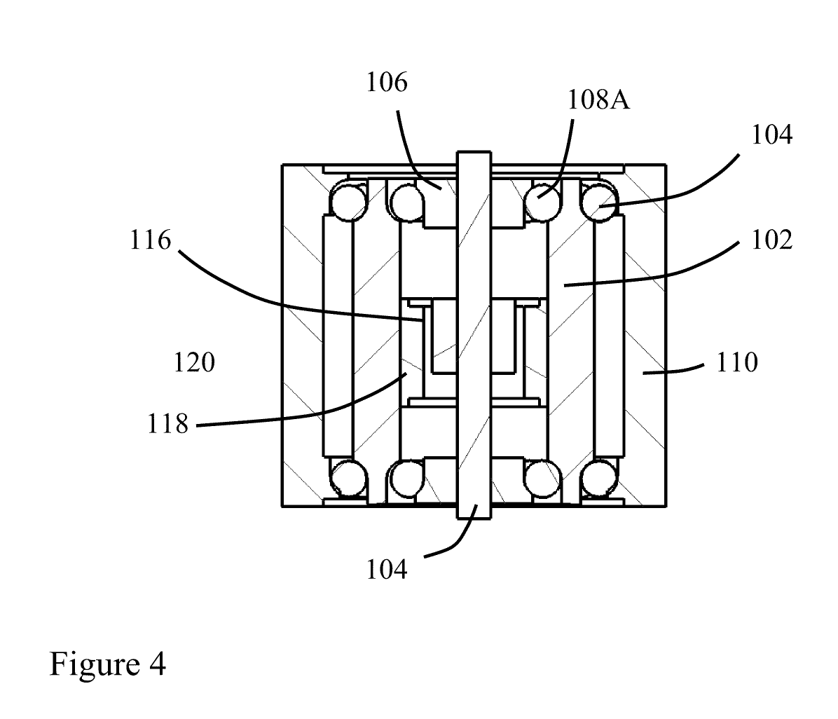

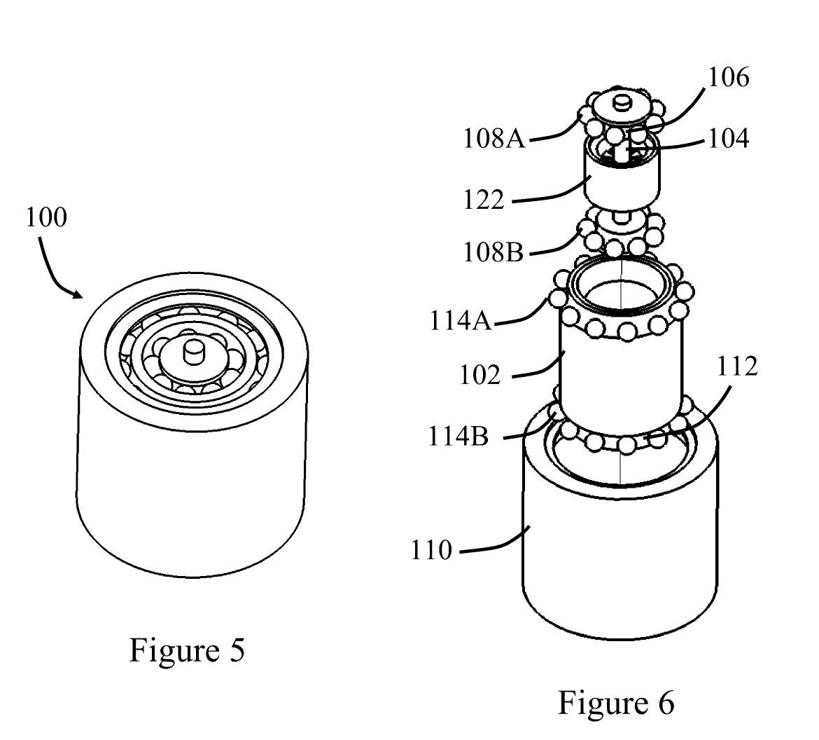

FIGS. 4 through 6 are various views of a pivot bearing 100 in accordance with an embodiment of the present invention. Inner sleeve 102 is rotatably supported on stationary shaft 104 by inner bearings 106. In the illustrated embodiment, the inner bearings 106 include upper bearing set 108A and lower bearing set 108B (collectively “108”). Consequently, the inner sleeve 102 is free to rotate concentrically around the stationary shaft 104. As will be discussed below, the inner bearings 106 can be subjected to a substantial pre-load without creating excessive hysteresis. In an alternate embodiment, the inner bearings 106 can be fixedly mounted to the inner sleeve 102.

Outer sleeve 110 is rotatably supported on inner sleeve 102 by outer bearings 112 (see FIG. 6). In the illustrated embodiment, the outer bearings 112 includes upper bearing set 114A and a lower bearing set 114B (collectively “114”). The outer bearings 112 are fixedly mounted to either the outer sleeve 110 or the inner sleeve 102. Consequently, the outer sleeve 110 is free to rotate concentrically around the inner sleeve 102 and the stationary shaft 104.

The bearing sets 108, 114 are includes pre-loaded ball bearings. The pre-load is provided to impart stiffness to the pivot bearing 100. Stiffness is proportional to the translation mode and is critical to the bandwidth of the servo system in high density disk drives. The increase in translation stiffness mitigates the effects of external vibrations and reduces tracking errors during read write operations.

An inner sleeve actuator 116 is located between the stationary shaft 104 and the inner sleeve 102. In the illustrated embodiment, flanges 122 created separation 124 between the inner bearings 106 in which the rotary actuator 116 is located. The flanges 122 may also provide support for the inner bearings 106.

In one embodiment, inner sleeve actuator 116 (shown in FIG. 4) is a DC motor with a magnet 118 mounted to the inner sleeve 102 and a stator 120 mounted to the stationary shaft 104. The inner sleeve actuator 116 continuously rotates the inner sleeve 102 relative to the stationary shaft 104, even if the outer sleeve 110 is stationary. The inner sleeve actuator 116 can also be referred to as an in sleeve motor. In another embodiment, inner sleeve actuator 116 is a voice coil motor.

Continuous rotation of the inner sleeve causes the bearing sets 108, 114 to be in continuous motion, eliminating the starting torque normally generated by the inner bearing 106 and/or the outer bearing 112. The need to move the ball bearings 108, 114 out of a stick/slip state into rotary movement is also eliminated. The continuously moving bearings 108, 114 also displace the lubricant and prevent a meniscus film of lubricant that causes stiction from forming. As a result the transient torque observed during start-up from a resting state, or when the direction of rotation is reversed, is substantially eliminated.

The power consumed by the inner sleeve actuator 116 is negligible since the rotational speed is preferably about 1 to about 10 revolutions per minute. In another embodiment, the inner sleeve actuator 116 is turned-off except during position critical rotation. As used herein, “position critical rotation” refers to track following, track-to-track seek operations, and other positioning activities that require high accuracy.

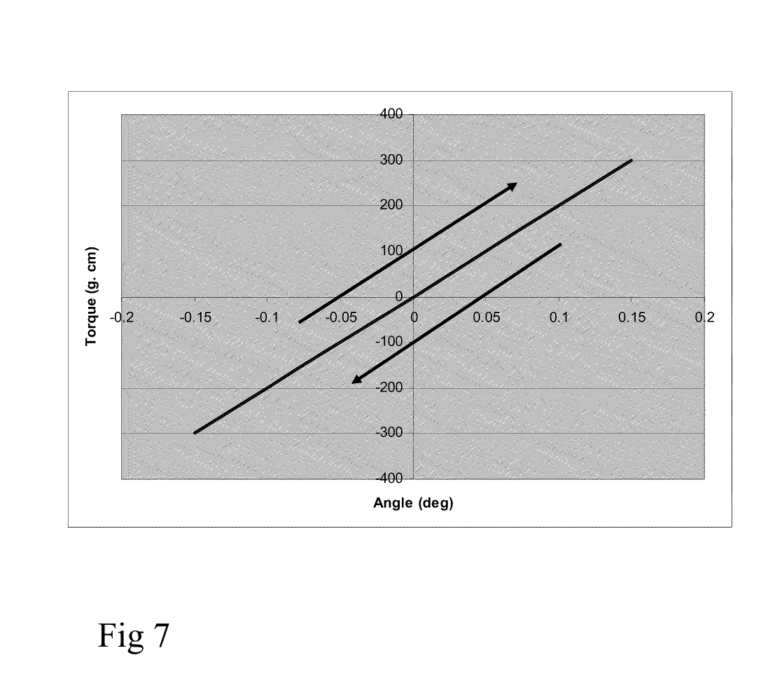

As illustrated in FIG. 7 the relationship between torque and angular displacement is substantially linear, with negligible residual hysteresis. The stiffness of the pivot bearing 100 is hence decoupled from the hysteresis loop, reducing translation error and the need for expensive micro-actuators on the head gimbal assembly.

During the rotation of the intermediary sleeve 102, a repeatable run-out motion is generated. In one embodiment, the pivot bearing 100 repeatable run-out is synchronized to the spindle run-out.

Depending on the rotational speed of the intermediary sleeve 102, a bias force may be transmitted to the outer sleeve 110. U.S. Pat. No. 7,031,098 (Park) compares several approaches to compensate for bias forces due to flex, which can be used to compensate for this bias.

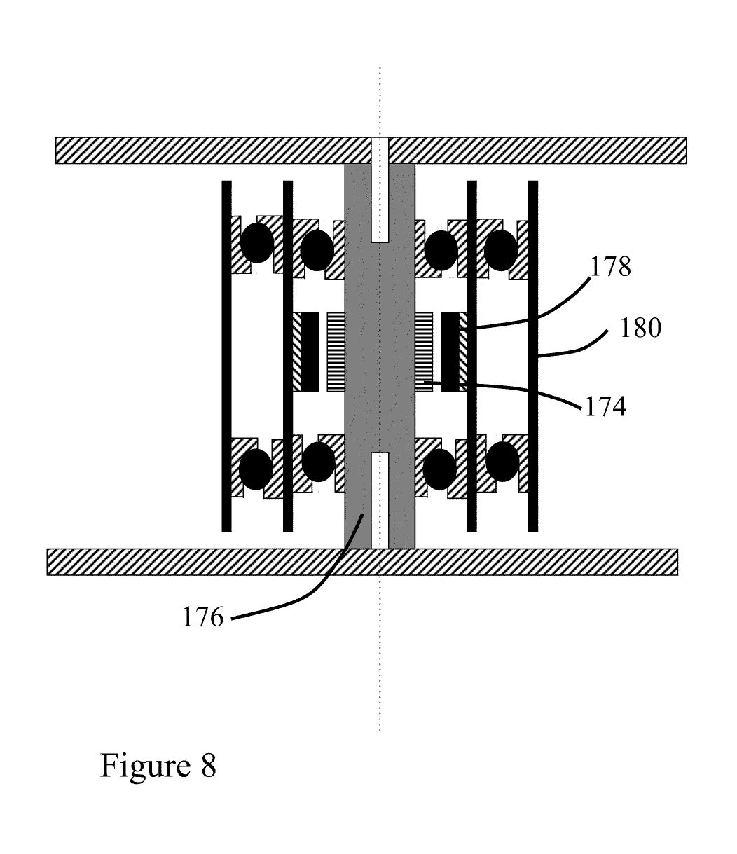

FIG. 8 illustrates the use of an integrated motor with a return flux assembly 178 comprised of a magnet and a back iron and a winding 174.

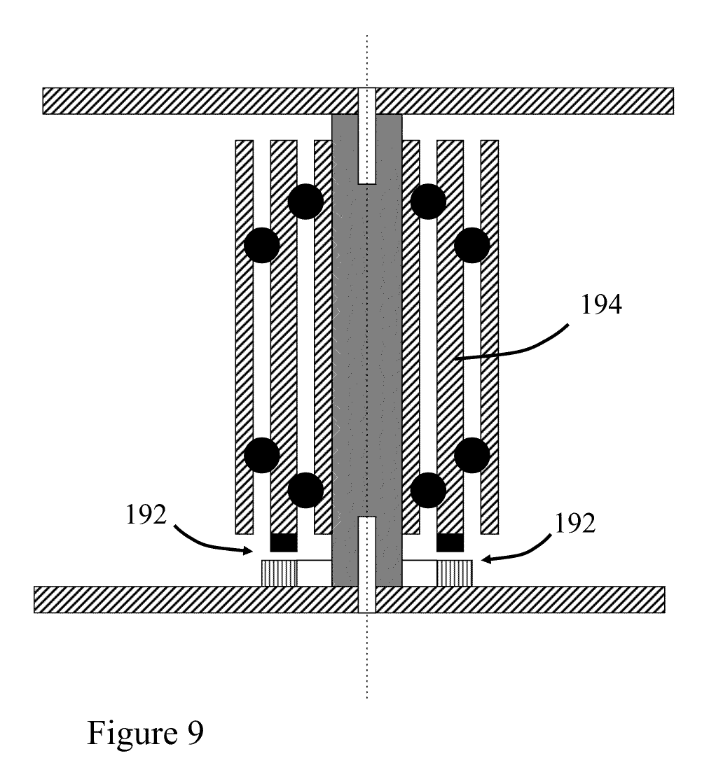

FIG. 9 illustrates the use of a pancake type motor 192 to actuate the inner sleeve 194 while in the case of an integrated motor.

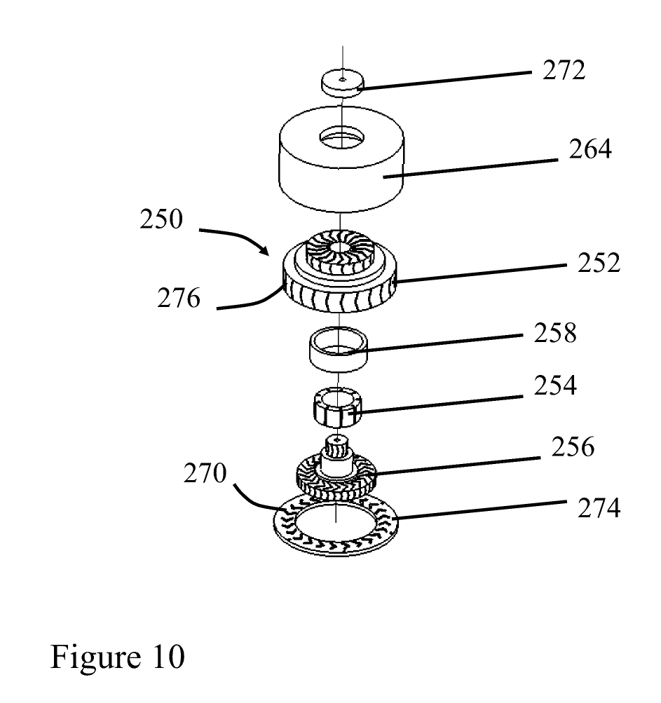

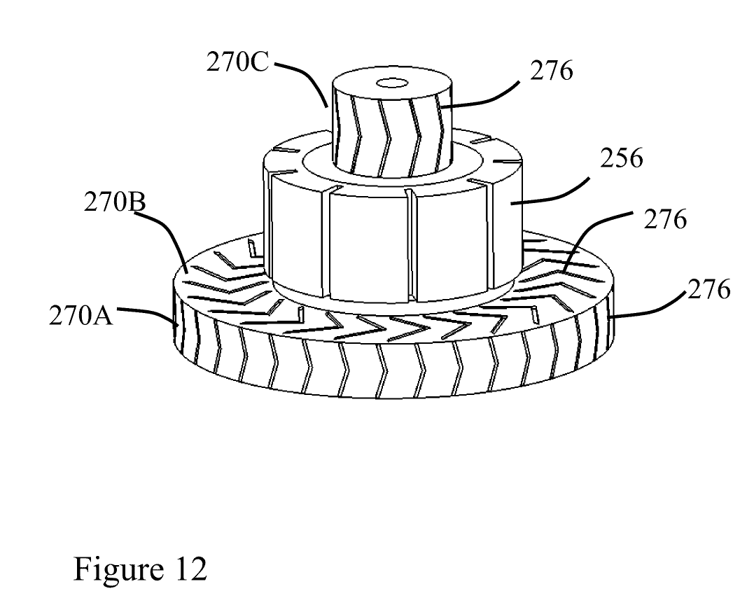

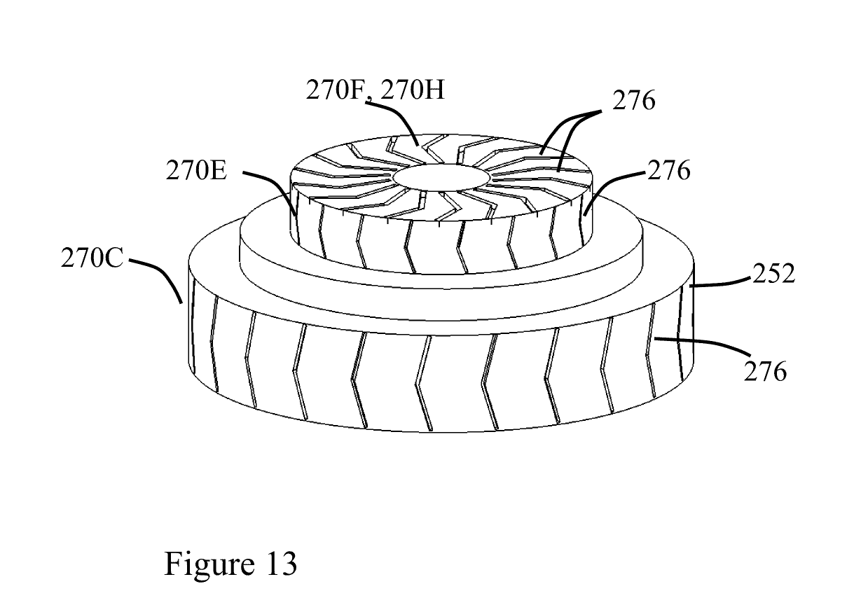

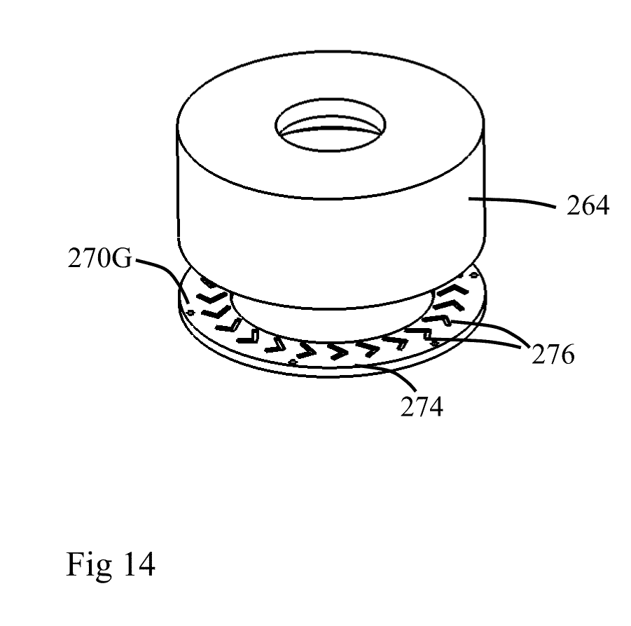

FIG. 10 through 14 illustrate various views of an alternate pivot bearing 250 in accordance with an embodiment of the present invention. The pivot bearing 250 is intended to operate at a high rotational speed sufficient to generate an air bearing or hydrodynamic film between the balls and the races. While this hydrodynamic embodiment is expected to have reduced hysteresis and improved life expectancy over conventional bearing structures, it will likely have greater run-out than the low rotational pivot bearing 100 discussed above.

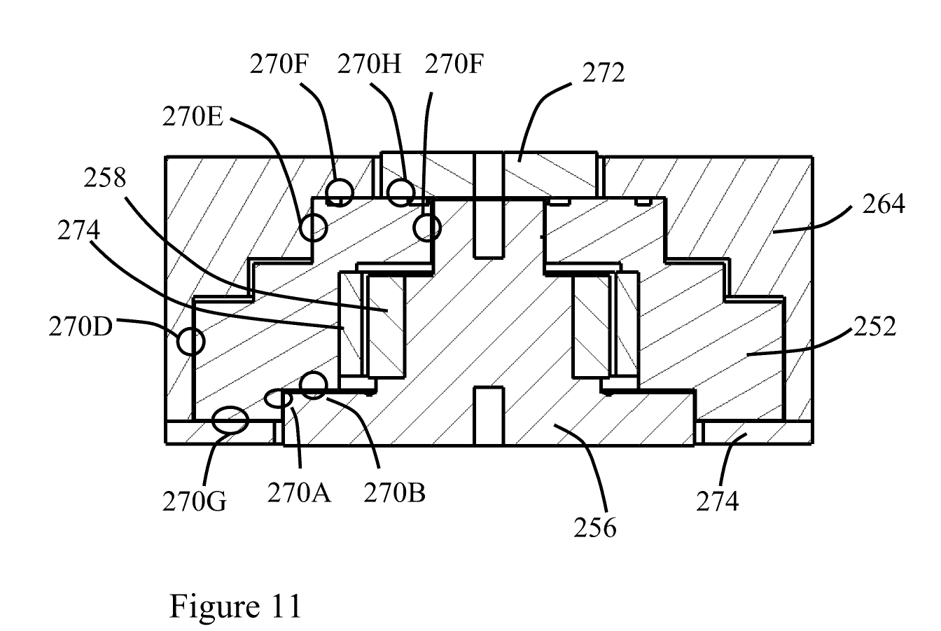

FIG. 11 provides a cross-sectional view of inner sleeve 252 energized by inner sleeve actuator 254 attached to the stationary bearing shaft 256. In the illustrated embodiment the inner sleeve actuator 254 is a DC brushless motor and herringbone oil bearing surfaces. The inner sleeve 252 contains a magnet assembly 258 to interface with the DC brushless motor 254.

The various interfaces 270A, 270B, 270C, 270D, 270E, 270F, 270G, 270H (collectively “270”) between the stationary bearing shaft 256, inner sleeve 252 and outer bearing shell 264 include hydrodynamic features 276. In the illustrated embodiment, the hydrodynamic features 276 are herringbone grooves. Various hydrodynamic features between rotating members are disclosed in U.S. Pat. No. 6,157,515 (Boutaghou), which is hereby incorporated by reference.

Rotation of the inner sleeve 252 creates an air bearing or hydrodynamic lift at the interfaces 270. The interfaces 270A, 270B, 270C are located between the inner sleeve 252 and the stationary bearing shaft 256. The interfaces 270D, 270E, 270F are located between the inner sleeve 252 and the outer bearing shell 264 connecting to a suspension arm. The interfaces 270G and 270H are located between the inner sleeve 252 and the top bearing plate 272 and the bottom bearing plate 274, respectively. The inner sleeve 252 is preferably rotated between 500 revolutions per minute (RPM) to several thousand RPM's.

The air bearing generated at the interfaces 270 provide stiffness to the entire pivot bearing 250. In one embodiment, an oil bearing contributes a spring-like action between the moving inner sleeve 252 and the stationary bearing shaft 256. The stiffness of the hydrodynamic oil bearing contributes to the translational stiffness of the pivot bearing 250. Herringbone surfaces are preferably fabricated on the bearing surfaces to pressurize the oil during the relative rotation of the mating surfaces.

Hydrodynamic bearings are very attractive as they offer both stiffness and high damping performance to the pivot bearing 250. Note since there are no rolling bearings the hysteresis effects are substantially eliminated.

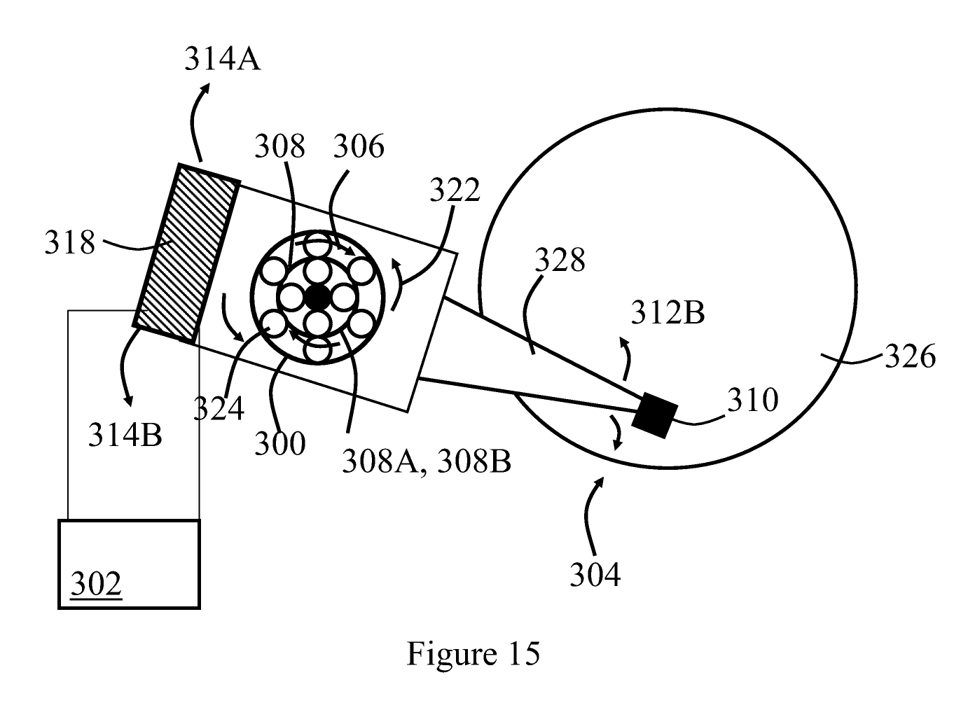

FIG. 15 discloses a method of operating a pivot bearing 300 in accordance with embodiments of the present invention. Controller 302 operates rotary actuators (see e.g., FIGS. 4, 8, 9A, 9B) on the pivot bearing 300. The controller 302 can either be the servo controller that operates voice coil motor 318 provided with hard disk drive 304 or a separate controller.

In one embodiment, the inner sleeve 308 rotates continuous in one direction. The controller 302 adjusts the input current/voltage to the voice coil motor 318 to counteract any torque applied to the suspension arm 328 by the pivot bearing 300. The controller 302 can optionally be turned off during idle operations to save power.

In one embodiment, torque 306 generated by rotation of the inner sleeve 308 is synchronized with torque 314A, 314B provided by voice coil motor 318. For example, if the transducer 310 needs to be moved in direction 312A, the controller 302 can rotate the inner sleeve 308 in the same direction 306. The torque 306 provided by the inner sleeve 308 augments the torque 314A on the outer sleeve 316 generated by the voice coil motor 318. Similarly, if the transducer 310 needs to move in the direction 312B, rotation of the inner sleeve 308 can be reversed to augment torque 314B on the outer sleeve 316 generated by the voice coil motor 318.

In another embodiment, the inner sleeve 308 is incrementally rotates, rather than continuously rotated. Small rotations of the inner sleeve 308 reduces the impact of run-out in the pivot bearing 300 on the transducer 310. For example, the input current/voltage to the inner sleeve actuators can be negatively proportional to the current applied to the voice coil motor 318. The negative current rotates the inner sleeve 308 a small amount and allows for the ball bearings 324 to rotate in the desired direction to overcome the hysteresis effect. The angular rotation of the inner sleeve 308 is preferably proportional to the angular rotation of the suspension arm 328. For example, if the suspension arm rotates about 10 minutes in direction 312B, the inner sleeve 308 preferably rotates about 10 minutes in the opposite direction 306. In one embodiment the current is applied to the inner sleeve actuators of the pivot bearing before the voice coil motor 318.

An opposite strategy can also be adopted that rotates the inner sleeve 308 in the same direction as the voice coil motor 318. The input current/voltage to the inner sleeve actuators on the pivot bearing 300 can have the same polarity as the input current to the voice coil motor 318. This method minimizes vibrations and allows for a smart dither-like behavior to be adopted for each disk drive track and zone.

In another embodiment, the controller 302 applies input current/voltage to the inner sleeve actuators of the inner sleeve 308 that is not necessarily the same or proportional to, the input current/voltage applied to the voice coil motor 318. For example, for current/voltage applied to the voice coil motor 318 within a certain range, a predetermined current/voltage is applied to the inner sleeve actuators in the pivot bearing 300. In another embodiment, a predetermined current/voltage is applied to the inner sleeve actuators in the pivot bearing 300 for each movement of the actuator arm 328.

The input current/voltage to the inner sleeve actuator(s) relative to the input current/voltage to the voice coil motor 318 is preferably calibrated. In one embodiment, the controller 302 positions the transducer 310 over a particular track on the rotating magnetic disk 326. The controller 302 then slowly ramps-up rotation of the inner sleeve 308 in the direction 306. Input current to the voice coil motor 318 increases to counteract the torque 306 generated by the pivot bearing 300 in order to maintain the transducer 310 over the particular track. Rotation of the inner sleeve 308 is then increased and the increased input current/voltage required by the voice coil motor 318 to counteract the increased torque 306 is recorded. The same calibration can be performed with the inner sleeve 308 rotating in the opposite direction.

In an embodiment where the inner sleeve 308 includes an upper inner sleeve 308A and lower inner sleeve 308B (collectively “308”), such as is illustrated in FIG. 8, the controller 302 preferably operates the upper and lower sleeves 308 independently. In one embodiment, the controller 302 positions the transducer 310 over a particular track on the rotating magnetic disk 326. The controller 302 then slowly ramps-up rotation of the upper and lower sleeves 308 in opposite directions so that the transducer 310 is maintained over the particular track. Input current to the voice coil motor 318 may be required to compensate for transient torques from the upper and lower sleeves 308 during the initial start-up phase. Eventually, the required rotation speeds of the upper and lower sleeves 308 are calibrated so that the torque applied by the pivot bearing 300 is minimized or eliminated. During the calibration process, torque applied by the pivot bearing 300 can be measured by the input current to the voice coil motor 318 required to maintain the transducer 310 over the particular track on the magnetic disk 326.

Where a range of values is provided, it is understood that each intervening value, to the tenth of the unit of the lower limit unless the context clearly dictates otherwise, between the upper and lower limit of that range and any other stated or intervening value in that stated range is encompassed within the inventions. The upper and lower limits of these smaller ranges which may independently be included in the smaller ranges is also encompassed within the inventions, subject to any specifically excluded limit in the stated range. Where the stated range includes one or both of the limits, ranges excluding either both of those included limits are also included in the inventions.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. A pivot bearing for use in a rotary actuator of a hard disk drive, the pivot bearing comprising:
a pivot shaft;
an inner sleeve pivotally attached to the pivot shaft by an inner bearing;
an outer sleeve pivotally attached to the inner sleeve by an outer bearing;
an inner sleeve actuator adapted to rotate at least one of the inner sleeves relative to the stationary shaft.

2. The pivot bearing of claim 1 wherein the inner sleeve actuator is coupled to the pivot shaft and one of an inner surface of the inner sleeve or a distal end of the inner sleeve.

3. The pivot bearing of claim 1 comprising hydrodynamic features at one or more interfaces between the pivot shaft, the inner sleeve, and the outer sleeve.

4. The pivot bearing of claim 1 wherein the inner sleeve actuator comprises a DC motor with a magnet mounted to one of the inner sleeve or the stationary shaft and a stator mounted to the other of the inner sleeve or the stationary shaft.

5. The pivot bearing of claim 1 wherein the inner sleeve actuator rotates the inner sleeve at about 1 revolution per minute to about 100 revolutions per minute.

6. The pivot bearing of claim 1 wherein a relationship of torque applied to the pivot bearing to angular displacement of the pivot bearing is substantially linear.

7. The pivot bearing of claim 1 comprising a controller programmed to actuate the inner sleeve actuator only during position critical rotation.

8. The pivot bearing of claim 12 wherein the controller is the servo controller for a hard disk drive.

9. A pivot bearing, the pivot bearing comprising:
a pivot shaft;
an inner sleeve pivotally attached to the pivot shaft by an inner bearing; and
an outer sleeve pivotally attached to the inner sleeve by an outer bearing.

10. A hard disk drive comprising:
at least one suspension arm that positions magnetic transducers over selected information tracks on rotating magnetic disks; and
a pivot bearing rotatably supporting the suspension arms relative to the rotating magnetic disks, the pivot bearing including at least one inner sleeve pivotally attached to a pivot shaft by an inner bearing, at least one outer sleeve pivotally attached to the inner sleeve by an outer bearing, and at least one inner sleeve actuator adapted to rotate the inner sleeve relative to the stationary shaft.

11. The hard disk drive of claim 10 further comprising a controller programmed to actuate the inner sleeve actuator of the pivot bearing only during position critical rotation.

12. The hard disk drive of claim 10 further comprising a controller programmed to rotate the inner sleeve of the pivot bearing continuously or intermittently.

13. The hard disk drive of claim 11 wherein the controller is at least a portion of a servo controller for the hard disk drive.

14. The pivot bearing of claim 10 further comprings a controller programmed to rotate the inner sleeve in a same direction or opposite direction of rotation of the outer sleeve.

15. The hard disk drive of claim 10 further comprising a controller programmed to apply one of a current or voltage to a voice coil motor attached to the suspension arm that is proportional to a current or voltage applied to the inner sleeve actuator.

16. A method of operating a hard disk drive comprising the steps of:
supporting at least one suspension arm by an outer sleeve of a pivot bearing;
rotating an inner sleeve of the pivot bearing arranged concentric with the outer sleeve relative to a pivot shaft; and
rotating the suspension arms and the outer sleeve independently from the rotation of the inner sleeve to position magnetic transducers attached to the suspension arms over selected information tracks on rotating magnetic disks.

17. The method of claim 16 comprising the step of rotating the inner sleeve in a range of about 1 revolution per minute to about 100 revolutions per minute.

18. The method of claim 16 comprising the step of rotating the inner sleeve at a rate sufficient to create an air bearing between at least one of the inner sleeve and the pivot shaft or the inner sleeve and the outer sleeve.

19. The method of claim 16 comprising rotating an upper portion of the inner sleeve in a first direction and rotating a lower portion of the inner sleeve in a second opposite direction.
